(19) United States
(12) Patent Application Publication
(10) Pub. No.: US 2025/0068891 A1
(43) Pub. Date: Feb. 27, 2025

(54) DYNAMIC TRIPLET CONVOLUTION FOR CONVOLUTIONAL NEURAL NETWORKS

(71) Applicant: Intel Corporation, Santa Clara, CA (US)

(72) Inventors: Dongqi CAI, Beijing (CN); Anbang YAO, Beijing (CN); Chao LI, Beijing (CN); Yurong CHEN, Beijing (CN); Wenjian SHAO, Shanghai (CN)

(21) Appl. No.: 18/724,510

(22) PCT Filed: Feb. 18, 2022
(86) PCT No.: PCT/CN2022/076853

§ 371 Date: Jun. 26, 2024

(51) Int. Cl. G06N 3/0464

(52) U.S. Cl. CPC G06N 3/0464

(57) ABSTRACT

Methods, apparatus, systems and articles of manufacture (e.g., physical storage media) to implement dynamic triplet convolution for convolutional neural networks are disclosed. An example apparatus disclosed herein for a convolutional neural network is to calculate one or more scalar kernels based on an input feature map applied to a layer of the convolutional neural network, ones of the one or more scalar kernels corresponding to respective dimensions of a static multidimensional convolutional filter associated with the layer of the convolutional neural network. The disclosed example apparatus is also to scale elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

### FIELD OF THE DISCLOSURE

This disclosure relates generally to convolutional neural networks and, more particularly, to dynamic triplet convolution for convolutional neural networks.

### BACKGROUND

Prior convolution neural networks (CNNs) typically utilize static convolutional filters (also referred to as convolutional kernels) to implement the layers of the CNNs. In such prior CNNs, the convolutional filter for a given CNN layer is trained via a training procedure. The trained convolutional filter then remains static, or unchanged, after the CNN is deployed to operate in its normal, or inference, operating mode, during which the trained convolutional filter is convolved with input feature maps applied to that layer of the CNN. More recently, techniques to implement dynamic convolutional filters for CNN layers have been developed. However, such techniques rely on linear combinations of multiple, trained convolutional filters to implement a single, dynamic convolutional filter.

### BRIEF DESCRIPTION OF THE DRAWINGS

FIG. 1 is a block diagram of an example convolution neural network (CNN) layer including example multi-scale attention kernel circuitry and example dimensional scaling circuitry to implement dynamic triplet convolution in accordance with teachings of this disclosure.

FIG. 2 is a block diagram illustrating an example implementation of the multi-scale attention kernel circuitry of FIG. 1.

FIG. 3 is a block diagram illustrating an example implementation of the multi-scale attention kernel circuitry and the dimensional scaling circuitry of FIG. 1.

FIGS. 4-7 are flowcharts representative of example machine readable instructions and/or example operations that may be executed by example processor circuitry to implement the multi-scale attention kernel circuitry, the dimensional scaling circuitry and/or the convolutional neural network layer of FIGS. 1, 2 and/or 3.

FIG. 8 is a block diagram of an example processor platform including processor circuitry structured to execute the example machine readable instructions of FIGS. 4, 5, 6 and/or 7 to implement the multi-scale attention kernel circuitry, the dimensional scaling circuitry and/or the convolutional neural network layer of FIGS. 1, 2 and/or 3.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 4, 5, 6 and/or 7) to client devices associated with end users and/or consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Methods, apparatus, systems and articles of manufacture (e.g., physical storage media) to implement dynamic triplet convolution for convolutional neural networks are disclosed herein. Dynamic triplet convolution, as disclosed herein, involves transforming a static multidimensional convolutional filter that is trained for a given convolution neural network (CNN) layer into a dynamic multidimensional convolutional filter through the use of one or more scalar kernels that dynamically scale one or more different dimensions of the static, multidimensional convolutional filter based on characteristics of the input feature map applied to that CNN layer. In some examples, dynamic triplet convolution, as disclosed herein, involves calculating one or more scalar kernels based on an input feature map applied to a layer of a CNN, with different ones of the scalar kernels corresponding to respective different dimensions of a static multidimensional convolutional filter associated with that layer of the CNN. In some such examples, dynamic triplet convolution also involves scaling elements of the static multidimensional convolutional filter along one or more of the different filter dimensions based on the respective scalar kernel(s) corresponding to the different dimension(s) to determine a dynamic multidimensional convolutional filter associated with that CNN layer. In some such examples, dynamic triplet convolution further involves processing (e.g., convolving) the input feature map with the dynamic multidimensional convolutional filter to determine an output feature map of that layer of the CNN. Because the multidimensional convolutional filters associated with CNN layers typically have three dimensions, namely, a spatial dimension, an input channel dimension and an output channel dimension, the convolution operation performed with a dynamic multidimensional convolutional filter, as disclosed herein, is referred to as “dynamic triplet convolution.”

As noted above, a conventional training paradigm for deep CNNs is to learn a single static convolutional kernel, also referred to as a multidimensional convolution filter (e.g., which may include a set of one or more convolutional filters), per layer. More recently, techniques to implement dynamic convolutional kernels, also referred to as dynamic multidimensional convolution filters or conditional multidimensional convolution filters, have been developed. Such recent techniques use a linear combination of multiple (e.g., N) static convolutional kernels, with the coefficient, or weights, used in the linear combination being determined dynamically. Lightweight CNNs employing such a dynamic, linear combination of convolutional kernels have demonstrated significant accuracy boost while retaining efficient inference. However, such dynamic, linear combinations of convolutional kernels can suffer from a linear increase in the number of the parameters in the convolutional layers, and may exhibit unsatisfactory performance when applied to relatively large CNNs.

Thus, despite the potentials of recent dynamic convolution designs employing dynamic, linear combinations of convolutional kernels, such designs suffer from at least two limitations. Firstly, replacing the original single static convolutional kernel at each convolutional layer by a linear combination of multiple (typically set to N=8 or 16) kernels leads to about a factor of N increase in memory cost for model storage. Secondly, although such recent dynamic convolution designs employing dynamic, linear combinations of convolutional kernels can exhibit satisfactory performance gain relative to conventional lightweight CNNs, the performance (e.g., accuracy) improvements for larger CNNs can be much smaller.

In contrast, example dynamic triplet convolution techniques disclosed herein overcome the storage and performance limitations of such prior dynamic convolution designs. Unlike the prior designs that rely on multiple additive dynamic convolutional kernels, example dynamic triplet convolution techniques disclosed herein insert a multi-scale attention mechanism into a layer of the CNN, which transforms the single, static multidimensional convolutional kernel into a dynamic multidimensional kernel without increasing the number of static multidimensional kernels used in that layer, as in prior dynamic techniques. As disclosed in further detail below, the multi-scale attention mechanism achieves this by utilizing the input feature map applied to the CNN layer to learn attentive scalar kernels along one or more of the spatial dimension, the input channel dimension and/or the output channel dimension of the filter (kernel) space. The learned scalar kernels are then applied to the single, static multidimensional convolutional kernel of the CNN layer via element-wise multiplication operations along the respective dimensions of the static multidimensional convolutional kernel. As such, example dynamic triplet convolution techniques disclosed herein can be implemented as a drop-in design that can be readily plugged into an existing CNN architecture. As a result, dynamic triplet convolution as disclosed herein can augment existing CNN architectures.

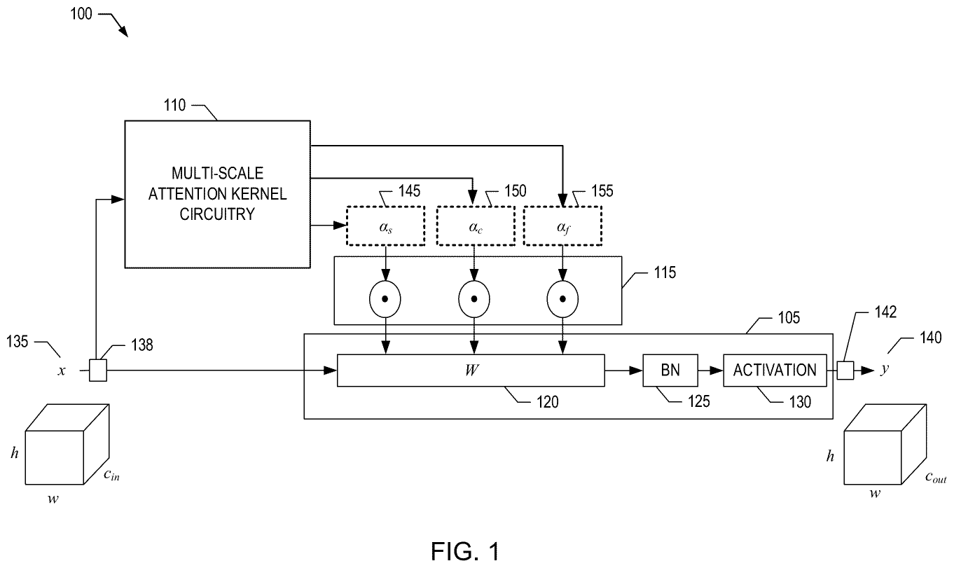

Turning to the figures, FIG. 1 is a block diagram of an example CNN layer 100 designed to implement dynamic triplet convolution in accordance with teachings of this disclosure. The example CNN layer 100 of FIG. 1 may be instantiated (e.g., creating an instance of, bring into being for any length of time, materialize, implement, etc.) by processor circuitry such as a central processing unit executing instructions. Additionally or alternatively, the example CNN layer 100 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by one or more virtual machines and/or containers executing on the microprocessor.

In the illustrated example of FIG. 1, the CNN layer 100 includes example convolutional layer circuitry 105, example multi-scale attention kernel circuitry 110 and example dimensional scaling circuitry 115. The convolutional layer circuitry 105 can correspond to any conventional or unconventional circuitry structured to implement a given layer of a CNN. In some examples, multiple instances of the convolutional layer circuitry 105 can be included in a CNN. For example, a first instance of the convolutional layer circuitry 105 can implement an input layer of the CNN that is to process input data (e.g., an image) applied to the CNN. Next, one or more second instances of the convolutional layer circuitry 105 can implement one or more intermediate, or hidden, layers of the CNN, with each intermediate layer to process an input feature set from a previous layer to generate a corresponding output feature map for that layer. Finally, a third instance of the convolutional layer circuitry 105 can implement an output layer of the CNN, which is to process the input feature map of the previous layer to produce a final output feature map that corresponds to the predicted, or inferred, output of the CNN.

As in a typical layer of a CNN, the convolutional layer circuitry 105 of the illustrated example implements an example static, multidimensional convolutional filter 120 (also referred to as a static convolutional kernel 120), an example batch normalizer 125 and an example activation function 130 that are used to process an example input feature map 135, which is applied to an example input interface 138 of the CNN layer 100, to generate an example output feature map 140, which is output by the CNN layer 100 via an example output interface 142. The input interface 138 and the output interface 142 can correspond to any type of data interface, such as, but not limited to, a memory interface, a register interface, a data structure, etc. In the illustrated example, to generate the output feature map 140, the convolutional layer circuitry 105 convolves the static, multidimensional convolutional filter 120 with the input feature map 135. As shown in FIG. 1, the convolutional layer circuitry 105 also performs batch normalization with the batch normalizer 125 on the output of the static, multidimensional convolutional filter 120, and applies the activation function 130 to the output of the batch normalizer 125 to generate the output feature map 140.

As shown in the illustrated example, the input feature map 135 is multidimensional data that has an input spatial dimension corresponding to a height dimension and a width dimension, and an input channel dimension. Furthermore, the static, multidimensional convolutional filter 120 has three dimensions corresponding to a filter spatial dimension, the input channel dimension and an output channel dimension. As a result, the output feature map 140 is also multidimensional data having an output spatial dimension and the output channel dimension.

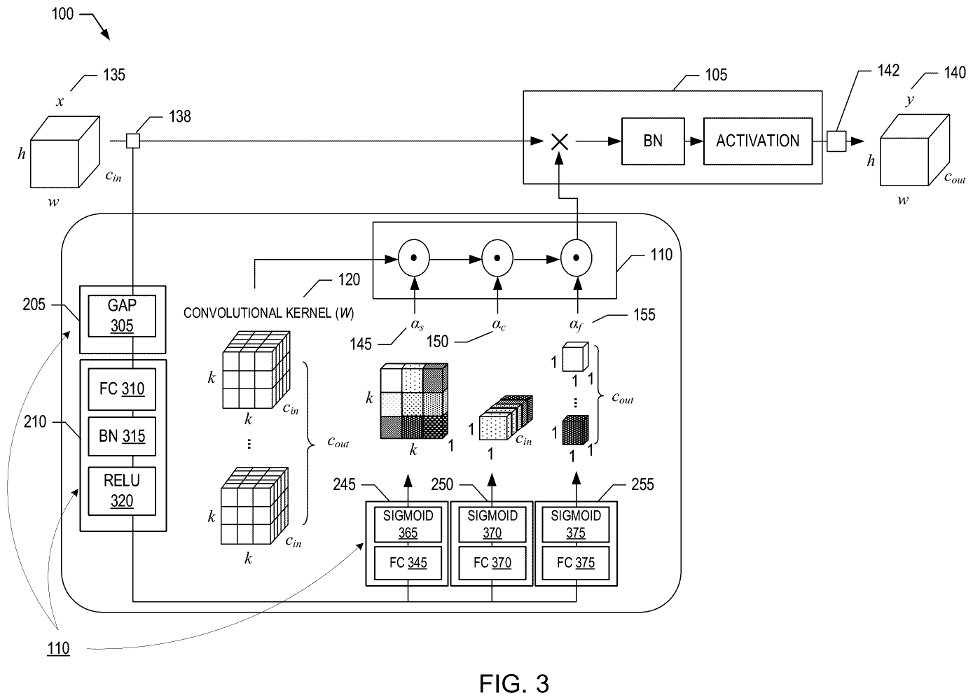

For example, if the convolutional layer circuitry 105 corresponds to an input layer of the CNN, then the spatial dimension of the input feature map 135 may correspond to the height and width of the input image data applied to the CNN, and the input channel dimension may be one (1) corresponding to the single image being applied to the input of the CNN. In such an example, the spatial dimension of the static, multidimensional convolutional filter 120 may correspond to a filter height and width that is be convolved over the height and width of the input image data applied to the CNN, the input channel dimension may be one (1), and the output channel dimension may correspond to the number of channel components of the static, multidimensional convolutional filter 120. (An example illustration of the multiple channel components of the static, multidimensional convolutional filter 120 is illustrated in FIG. 3, which is described in further detail below.) In the illustrated example of FIG. 1, the batch normalizer 125 and the activation function 130 operate to reduce the size of the resulting spatial dimension of the output feature map 140.

As another example, if the convolutional layer circuitry 105 corresponds to an intermediate (hidden) or output layer of the CNN, then the spatial dimension of the input feature map 135 may correspond to the spatial dimension (e.g., height and width) of the feature map generated by the preceding layer of the CNN, and the input channel dimension may correspond to the output channel dimension of the feature map generated by the preceding layer of the CNN. In such an example, the spatial dimension of the static, multidimensional convolutional filter 120 may correspond to a filter height and width that is be convolved over the height and width and input feature map 135, which is generated by the preceding layer; the input channel dimension of the multidimensional convolutional filter 120 may correspond to the channel dimension of the input feature map 135, which is generated by the preceding layer; and the output channel dimension of the multidimensional convolutional filter 120 may correspond to the number of channel components of the static, multidimensional convolutional filter 120 in that layer (which may be the same or different from the number of channel components in the filters of preceding or subsequent layers of the CNN). (As noted above, an example illustration of the multiple channel components of the static, multidimensional convolutional filter 120 is illustrated in FIG. 3, which is described in further detail below.) In the illustrated example of FIG. 1, the batch normalizer 125 and the activation function 130 again operate to reduce the size of the resulting spatial dimension of the output feature map 140 for that layer of the CNN.

In the illustrated example, the batch normalizer 125 and the activation function 130 can implement any conventional or unconventional batch normalization procedure and activation function, respectively, to reduce the size of the spatial dimension (e.g., height and width) of the output feature map 140. For example, the batch normalization procedure implemented by the batch normalizer 125 can normalize the output of the static, multidimensional convolutional filter 120 based on the mean and variance of the output data. In some examples, the batch normalization procedure may additionally or alternatively perform averaging of the filter output data over the spatial dimension to reduce the size of the spatial dimension (e.g., height and width) of the output feature map 140. In some examples, the activation function 130 can implement any conventional or unconventional activation function, such as a rectified linear unit (ReLU) function, a sigmoid, function, etc.

In the illustrated example of FIG. 1, the convolutional layer circuitry 105 learns, or trains, the static, multidimensional convolutional filter 120 based on training data during a training mode of operation of the convolutional layer circuitry 105. Then, the static, multidimensional convolutional filter 120 remains static, or fixed, when the convolutional layer circuitry 105 operates in an inference mode to predict, or infer, output data based on input data applied to the convolutional layer circuitry 105.

In the illustrated example of FIG. 1, the CNN layer 100 includes the multi-scale attention kernel circuitry 110 and the dimensional scaling circuitry 115 to implement dynamic triplet convolution in accordance with teachings of this disclosure. As mentioned above, recent techniques to implement dynamic convolutional filters for CNN layers rely on a linear combination of an ensemble of multiple (e.g., N=8 or 16), trained convolutional filters to implement a single, dynamic convolutional filter to replace the static, multidimensional convolutional filter 120. In contrast with such prior techniques, dynamic triplet convolution incorporates the multi-scale attention kernel circuitry 110 to learn, from the input feature map 135, one or more of an example attentive scalar kernel 145 corresponding to the spatial dimension of the filter 120, an example attentive scalar kernel 150 corresponding to the input channel dimension of the filter 120, and/or an example attentive scalar kernel 155 corresponding to the output channel dimension of the filter 120. The dimensional scaling circuitry 115 then utilizes one or more of the spatial scalar kernel 145, the input channel kernel 150 and/or the output channel kernel 155 to dynamically adjust the elements of the static, multidimensional convolutional filter 120 along the spatial, input channel and output channel dimensions, respectively, to effectively yield a dynamic, multidimensional convolutional filter that is convolved by the convolutional layer circuitry 105 with the input feature map 135. In this way, the number of extra parameters (e.g., corresponding to the scalar kernels 145-155) introduced by dynamic triplet convolution, as disclosed herein, is negligible and depends on the sum of the original size of the static, multidimensional convolutional filter 120 along all three dimensions.

To further understand the implementation and operation of the CNN layer 100 to perform dynamic triplet convolution as disclosed herein, first consider a typical convolution [symbol] operation performed by a CNN layer. For example, let X∈ [symbol] ^{c}^{ᵢₙ}^{×h×w} denote an input feature map, such as the input feature map 135, where h and w represent the spatial height and width of the input feature map 135, respectively, and cᵢₙ denotes the number of channels of the input feature map 135. As such, the input feature map 135 (X) is a multidimensional set of real value data with h data elements along the height dimension, w elements along the width dimension, and cᵢₙ elements along the input channel dimensions. Next, consider a conventional convolutional operation performed with a multidimensional convolutional filter, such as the multidimensional convolutional filter 120, having cₒᵤₜ output channels and with filter (or kernel) spatial size of k×k. Such a multidimensional convolutional filter 120 can be represented mathematically as W∈ [symbol] ^{c}^{ₒᵤₜ}^{×c}^{ᵢₙ}^{×k×k}. To simplify the notation, the spatial filter (kernel) size k×k of the multidimensional convolutional filter 120 (W) is denoted as the spatial dimension, s, in the following disclosure.

Using the preceding notation, a typical convolution operation performed by a CNN layer can be written according to Equation 1, which is:

$$Y = X * W \qquad Equation 1$$

In Equation 1, the notation “*” denotes the typical convolutional operation, and Y∈ [symbol] ^{c}^{ₒᵤₜ}^{×h×w} corresponds to an output feature map, such as the output feature map 140. As discussed above, the multidimensional convolutional filter (W) of a CNN layer, such as the multidimensional convolutional filter 120 of the CNN layer 100, is static or, in other words, the elements of the multidimensional convolutional filter 120 (W) are fixed (or unchanged) after training and applied to all input feature sets 135 applied to that CNN layer 100.

Different from conventional static convolutional implementation, the prior dynamic convolutional implementations noted above are sample-adaptive and can be formulated mathematically according to Equation 2, which is:

$$Y = X * \tilde{W} = X * ( {\sum }_{n = 1}^{N} {π}_{n} {ℱ}_{n} ) \qquad Equation 2$$

In Equation 2, the set of parameters πₙ, n=1, 2, . . . N is dynamically generated by an attention block to adaptively assemble a linear combination of N convolutional filters (or kernels). When using such prior dynamic convolutional filter implementations to replace conventional, static convolutional implementation, an additional N times memory cost for model storage can be incurred. Also, prior dynamic convolution techniques apply the attention mechanism merely to one of three dimensions of the convolutional kernel, thereby limiting the capability of such prior dynamic convolution designs to a substantial extent.

In contrast, to implement dynamic triplet convolution techniques, as disclosed herein, the multi-scale attention kernel circuitry 110 and the dimensional scaling circuitry 115 are inserted in the CNN layer 100 to augment the static, multidimensional convolutional filter 120 (or kernel 120), W, already implemented by the convolutional layer circuitry 105. In some examples, the multi-scale attention kernel circuitry 110 dynamically generates the attentive scalar kernels 145-155 corresponding to all three dimensions of the convolutional filter (kernel) space (e.g., W∈ [symbol] ^{c}^{ₒᵤₜ}^{×c}^{ᵢₙ}^{×s}, where s corresponds to the spatial dimension, cᵢₙ corresponds to input channel dimension, and cₒᵤₜ corresponds to the output channel dimension of the filter, or kernel, space). More specifically, the multi-scale attention kernel circuitry 110 in such an example generates the scalar kernel 145 corresponding to the spatial dimension of the convolutional filter (kernel) space, the scalar kernel 150 corresponding to the input channel dimension of the convolutional filter (kernel) space, and the scaler kernel 155 corresponding to the output channel dimension of the convolutional filter (kernel) space. The spatial scalar kernel 145 can be represented mathematically as αₛ∈ [symbol] ^{1×1×s} and includes a number of values corresponding to the size (e.g., height by width) of the spatial dimension of the convolutional filter (kernel) space. The input channel scalar kernel 150 can be represented mathematically as α_{c}∈ [symbol] ^{1×c}^{ᵢₙ}^{×1}, and includes a number of values corresponding to the size (e.g., can) of the input channel dimension of the convolutional filter (kernel) space. The output channel scalar kernel 155 can be represented mathematically as α_{f}∈ [symbol] ^{c}^{ₒᵤₜ}^{×1×1}, and includes a number of values corresponding to the size (e.g., cₒᵤₜ) of the output channel dimension of the convolutional filter (kernel) space. In some examples, the multi-scale attention kernel circuitry 110 generates a subset of one or two of the scalar kernels 145-155 rather than generating all three of the scalar kernels 145-155.

Next, the dimensional scaling circuitry 115 uses one or more of the scalar kernels 145-155 to dynamically scale the original static, multidimensional convolutional filter 120 (or kernel 120) along its different dimensions to transform the static, multidimensional convolutional filter 120 into a dynamic multidimensional convolutional filter. In examples in which all three scalar kernels 145-155 are generated, which corresponds to dynamic triplet convolution, the dimensional scaling circuitry 115 scales the static, multidimensional convolutional filter 120 by the scalar kernels 145-155 along their respective dimensions, and the convolutional layer circuitry 105 convolves the resulting dynamic convolutional filter with the input feature map 135 (X) according to Equation 3, which is:

$$Y = X * ( W ⊙ {α}_{s} ⊙ {α}_{c} ⊙ {α}_{f} ) \qquad Equation 3$$

In Equation 3, the notation “O” denotes element-wise multiplication operations along the respective dimensions corresponding to the scalar kernels 145-155. Through multiplying the static, multidimensional convolutional filter 120 with the three scalar kernels 145-155 (αₛ, α_{c}, α_{f}) along their respective dimensions, the multidimensional convolutional filter 120 for modeling input data features is augmented with flexible adaptiveness. Also, as discussed in further detail below, the scalar kernels 145-155 (αₛ, α_{c} and α_{f}) are generated by the multi-scale attention kernel circuitry 110 in an efficient way, which can be represented mathematically according to Equation 4, which is:

$$[ {α}_{s} , {α}_{c} , {α}_{f} ] = MSA ( X ) \qquad Equation 4$$

In examples in which the multi-scale attention kernel circuitry 110 generates a subset of one or two of the scalar kernels 145-155 rather than generating all three scalar kernels 145-155, the dimensional scaling circuitry 115 can omit the scaling operations of Equation 3 for the one or more scalar kernels 145-155 that are not generated. Alternatively, for the one or more scalar kernels 145-155 that are not generated by the multi-scale attention kernel circuitry 110 in such examples, the dimensional scaling circuitry 115 can utilize a unity scalar kernel having values of one (1) for the missing scalar kernels 145-155 in Equation 3.

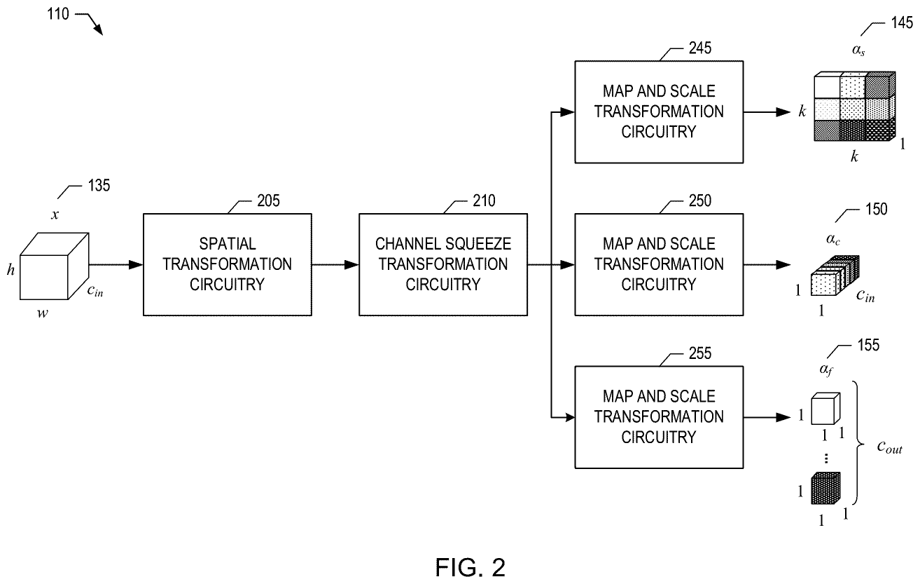

A block diagram of an example implementation of the multi-scale attention kernel circuitry 110 of FIG. 1 is illustrated in FIG. 2. The example multi-scale attention kernel circuitry 110 of FIG. 2 may be instantiated (e.g., creating an instance of, bring into being for any length of time, materialize, implement, etc.) by processor circuitry such as a central processing unit executing instructions. Additionally or alternatively, the example multi-scale attention kernel circuitry 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

The example multi-scale attention kernel circuitry 110 of FIG. 2 is a lightweight structure designed to compute attentive scalar kernels along three dimensions of convolution filter (kernel) space based on the input feature map 135 applied to the CNN layer 100. In the example of FIG. 2, the multi-scale attention kernel circuitry 110 includes example spatial transformation circuitry 205, example channel squeeze transformation circuitry 210, and respective instances of example map and scale transformation circuitry 245-255 corresponding to the different scalar kernels 145-144 to be computed along the three dimensions of convolution filter (kernel) space. In the illustrated example, spatial transformation circuitry 205 performs a first transformation on the input feature map 135 that aggregates the input feature map 135 across spatial dimensions to produce a first transformed feature map, also referred to as a channel descriptor. This channel descriptor represents a global distribution of channel-wise feature responses. An example implementation of the spatial transformation circuitry 205 is illustrated in FIG. 3, which is described in further detail below.

In the illustrated example, the channel squeeze transformation circuitry 210 performs a second transformation on the first transformed feature map (or channel descriptor) output from the spatial transformation circuitry 205 to yield a second transformed feature map, also referred to as an abstraction descriptor, that provides a further level of abstraction of the input feature map 135. In some examples, the second transformation implemented by the channel squeeze transformation circuitry 210 includes applying a channel squeeze operation followed by an activation function to the first transformed feature map (or channel descriptor) to produce the second transformed feature map (or abstraction descriptor). An example implementation of the channel squeeze transformation circuitry 210 is illustrated in FIG. 3, which is described in further detail below.

In the illustrated example of FIG. 2, the three instances of the map and scale transformation circuitry 245-255 operate to map and scale the second transformed feature map (or abstraction descriptor) output from the channel squeeze transformation circuitry 210 to the sizes of different dimensions of convolution filter (kernel) space and output the three corresponding attentive scalar kernels 145-155 (e.g., αₛ, α_{c} and α_{f}), respectively. As described above in the context of Equation 3, the dimensional scaling circuitry 115 then multiplies the static, multidimensional convolutional filter (kernel) 120 by the scalar kernels 145-155 in an element-wise product manner along their respective filter (kernel) dimensions to obtain the dynamic, multidimensional filter (kernel) to be used to perform dynamic triplet convolution in the CNN layer 100. In examples in which just a subset of the scalar kernels 145-155 are to be generated, the multi-scale attention kernel circuitry 110 of FIG. 2 can be structured to include just those instances of the map and scale transformation circuitry 245-255 that correspond to the ones of the scalar kernels 145-155 to be generated.

As can be seen in the examples of FIG. 1 and FIG. 2, and also in the example of FIG. 3, which is described in further detail below, the multi-scale attention kernel circuitry 110 can be embedded in any convolutional layer of a CNN, enabling easy end-to-end training.

FIG. 3 is another block diagram of the example CNN layer 100 that illustrates a more detailed, example implementation of the multi-scale attention kernel circuitry 110 of FIG. FIG. 2. The example CNN layer 100 of FIG. 3 may be instantiated (e.g., creating an instance of, bring into being for any length of time, materialize, implement, etc.) by processor circuitry such as a central processing unit executing instructions. Additionally or alternatively, the example CNN layer 100 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

In the illustrated example of FIG. 3, the CNN layer 100 includes the example convolutional layer circuitry 105, the example multi-scale attention kernel circuitry 110, the example dimensional scaling circuitry 115, the input interface 138 and the output interface 142, as described above. The multi-scale attention kernel circuitry 110 of FIG. 3 also includes the example spatial transformation circuitry 205, the example channel squeeze transformation circuitry 210, and the example map and scale transformation circuitry 245, 250 and 255, as described above. In the illustrated example of FIG. 3, the spatial transformation circuitry 205 of the multi-scale attention kernel circuitry 110 is implemented by example global average pooling (GAP) circuitry 305 that performs a GAP transformation or any other average pooling transformation on the input feature map 135 applied to the CNN layer 100 to produce the first transformed feature map (or channel descriptor) described above. For example, the GAP transformation performed by the GAP circuitry 305 may perform spatial aggregation of the input feature map 135 by replacing the spatial elements in each channel of the input feature map 135 with a global average of the spatial elements in that channel of the input feature map 135 to produce the first transformed feature map (or channel descriptor).

In the illustrated example of FIG. 3, the channel squeeze transformation circuitry 210 implements an example fully connected (FC) neural network layer 310 (also referred to as an example FC layer 310), an example batch normalizer 315 and an example activation function 320 to perform a channel squeeze and activation transformation on the first transformed feature map (or channel descriptor) that is output from the spatial transformation circuitry 205 (e.g., the GAP circuitry 305). For example, the FC layer 310 may be structured or otherwise configured with a squeeze ratio of r to reduce the dimensionality of the first transformed feature map (or channel descriptor) from the full input channel size of cᵢₙ to a reduced input channel size of cᵢₙ/r. In the illustrated example of FIG. 3, the channel squeeze transformation circuitry 210 further implements the batch normalizer 315 to perform a batch normalization operation on the output of the FC layer 310 and the activation function 320 to perform an example rectified linear unit (ReLU) activation function (or any other activation function) on the output of the batch normalizer 315 to produce the second transformed feature map (or abstraction descriptor) described above.

In the illustrated example of FIG. 3, the respective instances of the map and scale transformation circuitry 245, 250 and 255 implement respective example FC layers 345, 350 and 355, followed by respective example activation functions 365, 370 and 375 to map and scale the second transformed feature map (or abstraction descriptor) output from the channel squeeze transformation circuitry 210 (e.g., including the FC layer 310, the batch normalizer 315 and the activation function 320) to produce respective scalar kernels 145-155 (e.g., αₛ, α_{c} and α_{f}) described above. For example, the respective FC layers 345, 350 and 355 of the different instances of the map and scale transformation circuitry 245, 250 and 255 may be structured or otherwise configured to map the second transformed feature map (or abstraction descriptor) from its reduced input channel size of cᵢₙ/r to the corresponding dimensionalities of the respective scalar kernels 145-155 (e.g., αₛ∈ [symbol] ^{1×1×s}, α_{c}∈ [symbol] ^{1×c}^{ᵢₙ}^{×1} and α_{f}∈ [symbol] ^{c}^{ₒᵤₜ}^{×1×1}). Furthermore, the activation functions 365, 370 and 375 may implement a sigmoid activation function (or any other activation function) to scale the outputs of the respective FC layers 345, 350 and 355 to produce the calculated values of the respective scalar kernels 145-155 (e.g., αₛ, α_{c} and α_{f}) learned from the input feature map 135. As noted above, one or more of the instances of the map and scale transformation circuitry 245, 250 and 255 can be omitted or bypassed for any of the scalar kernels 145-155 that are not to be generated for the CNN layer 100.

As described above, the dimensional scaling circuitry 115 of the FIG. 3 scales the static, multidimensional convolutional filter 120, with the scalar kernels 145-155 along their respective dimensions of the filter (kernel) space as shown in Equation 3 above. As further described above, the scaling performed by the dimensional scaling circuitry 115 corresponds to element wise multiplication of the static, multidimensional convolutional filter 120 by the scalar kernels 145-155 along their respective dimensions of the filter (kernel) space. Such scaling can be represented mathematically as follows. Let the elements of the static, multidimensional convolutional filter 120 be represented by W={w^{i,j,k}}∈ [symbol] ^{c}^{ₒᵤₜ}^{×c}^{ᵢₙ}^{×s}. Let the elements of the spatial scalar kernel 145 be represented by αₛ{αₛ^{k}}∈ [symbol] ^{1×1×s} which includes a first number of elements (e.g., s=height×width) corresponding respectively to positions of the static multidimensional convolutional filter 120 along the spatial dimension. Let the elements of the input channel scalar kernel 150 be represented by α_{c}={α_{c}^{j}}∈ [symbol] ^{1×c}^{ᵢₙ}^{×1}, which includes a second number of elements (e.g., can) corresponding respectively to positions of the static multidimensional convolutional filter 120 along the input channel dimension. Let the elements of the output channel scalar kernel 155 be represented by α_{f}={α_{f}ⁱ}∈ [symbol] ^{c}^{ₒᵤₜ}^{×1×1}, which includes a third number of elements (e.g., cₒᵤₜ) corresponding respectively to positions of the static multidimensional convolutional filter 120 along the output filter dimension. In the preceding expression, the variable i is an index over the number of output channels (e.g., cₒᵤₜ), the variable j is an index over the number of input channels (e.g., cᵢₙ), and the variable k is an index over the spatial dimension of the filter (kernel) space (e.g., s).

Based on the foregoing expressions, the element-wise scaling performed by the dimensional scaling circuitry 115 along the dimensions corresponding to the different scalar kernels 145-155 can be represented by the following equations. For example, initial scaling of the multidimensional convolutional filter 120 with the spatial scalar kernel 145 can be represented by Equation 5, which is:

$$\dot{W} = \{ {\dot{w}}^{i , j , k} \} = {w}^{i , j , k} \times {α}_{s}^{k} , \qquad Equation 5$$

$$for$$

$$i = 1 … {c}_{out}$$

$$j = 1 … {c}_{in}$$

$$k = 1 … s$$

Subsequent scaling with the input channel scalar kernel 150 can be represented by Equation 6, which is:

$$\ddot{W} = \{ {\ddot{w}}^{i , j , k} \} = {\dot{w}}^{i , j , k} \times {α}_{c}^{j} , \qquad Equation 6$$

$$for$$

$$i = 1 … {c}_{out}$$

$$j = 1 … {c}_{in}$$

$$k = 1 … s$$

Subsequent scaling with the output channel scalar kernel 155 can be represented by Equation 7, which is:

$$= \{ {i , j , k}^{} \} = {\ddot{w}}^{i , j , k} \times {α}_{f}^{i} , \qquad Equation 7$$

$$for$$

$$i = 1 … {c}_{out}$$

$$j = 1 … {c}_{in}$$

$$k = 1 … s$$

Thus, in Equation 7, the resulting filter [symbol] ={ [symbol] ^{i,j,k}} corresponds to the resulting dynamic multidimensional filter (kernel) output from the dimensional scaling circuitry 115. Of course, the order of scaling of the static, multidimensional convolutional filter 120 by the respective scalar kernels 145-155 can vary from the order shown in Equations 5-7 due to the commutative property of multiplication. Also, for examples in which the spatial dimension s has a height dimension and a width dimension, Equation 5 above can be rewritten as Equation 8, which is:

$$\dot{W} = \{ {\dot{w}}^{i , j , {k}_{h} , {k}_{w}} \} = {w}^{i , j , {k}_{h} , {k}_{w}} \times {α}_{s}^{{k}_{h} , {k}_{w}} , \qquad Equation 8$$

$$for$$

$$i = 1 … {c}_{out}$$

$$j = 1 … {c}_{in}$$

$${k}_{h} = 1 … {s}_{h}$$

$${k}_{w} = 1 … {s}_{W}$$

In Equation 8, kₕ=1 . . . sₕ indexes over the height dimension of the filter spatial dimension, and k_{w}=1 . . . s_{w} indexes over the width dimension of the filter spatial dimension.

In the illustrated example of FIG. 3, the parameters (e.g., filter weights) of the static, multidimensional convolutional filter 120, the parameters of the FC layer 310 of the channel squeeze transformation circuitry 210 and the parameters of the FC layers 345, 350 and 355 of the instances of the map and scale transformation circuitry 245-255 are trained based on training data during a training mode of operation of the CNN layer 100. Then during the normal, inference mode of operation of the CNN layer 100, the parameters of the static, multidimensional convolutional filter 120, the FC layer 310 and the FC layers 345, 350 and 355 remain static (or fixed). However, during the normal, inference mode of operation of the CNN layer 100, the static parameters of the FC layer 310 and the FC layers 345, 350 and 355 are used to calculate the respective scalar kernels 145-155 (e.g., αₛ, α_{c} and α_{f}) dynamically based on the particular input feature map 135 applied to the CNN layer 100. When a new (e.g., second) input feature map 135 is subsequently applied to the CNN layer 100, the static parameters of the FC layer 310 and the FC layers 345, 350 and 355 are again used to calculate new, respective scalar kernels 145-155 (e.g., αₛ, α_{c} and α_{f}) dynamically based on that new input feature map 135, and so on.

Thus, implementation of dynamic triplet convolution in the CNN layer 100 of FIG. 3 incurs a total extra parameter cost of

$${c}_{in} \times \frac{{c}_{in}}{r} + \frac{{c}_{in}}{r} \times ( {c}_{out} + {c}_{in} + s )$$

additional parameters, where the

$${c}_{in} \times \frac{{c}_{in}}{r}$$

additional parameters correspond to the FC layer 310, and the

$$\frac{{c}_{in}}{r} \times ( {c}_{out} + {c}_{in} + s )$$

additional parameters correspond to the FC layers 345, 350 and 355. For example, with a squeeze ratio r=4 and a filter (kernel) dimensionality of cᵢₙ=256, cₒᵤₜ=512 and s=3×3=9, the number of extra parameters introduced to the CNN layer 100 by dynamic triplet convolution is just about 5% of the number of parameters in the original static multidimensional filter (kernel) 120 (e.g., cₒᵤₜ×cᵢₙ×s), which is quite a lightweight design.

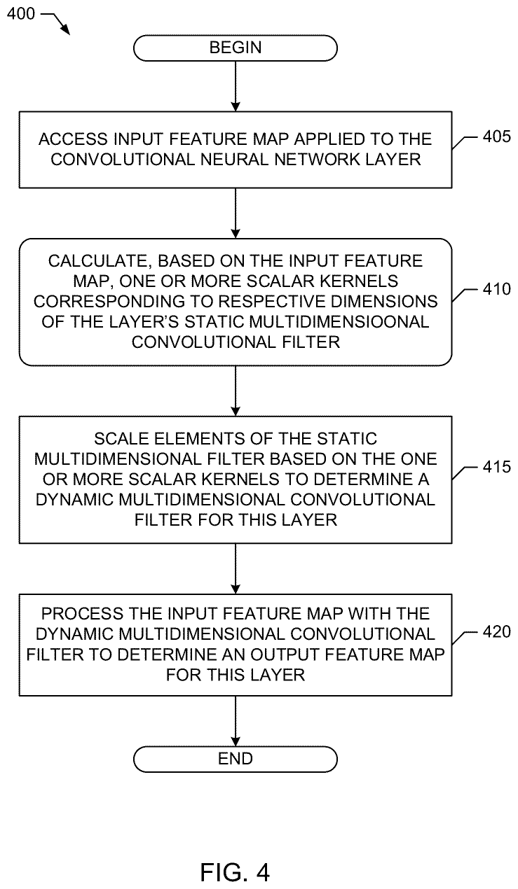

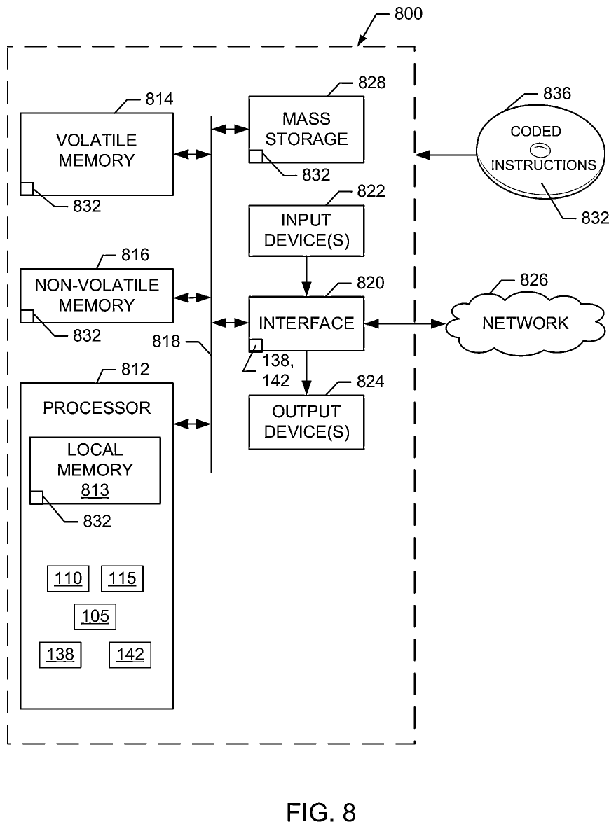

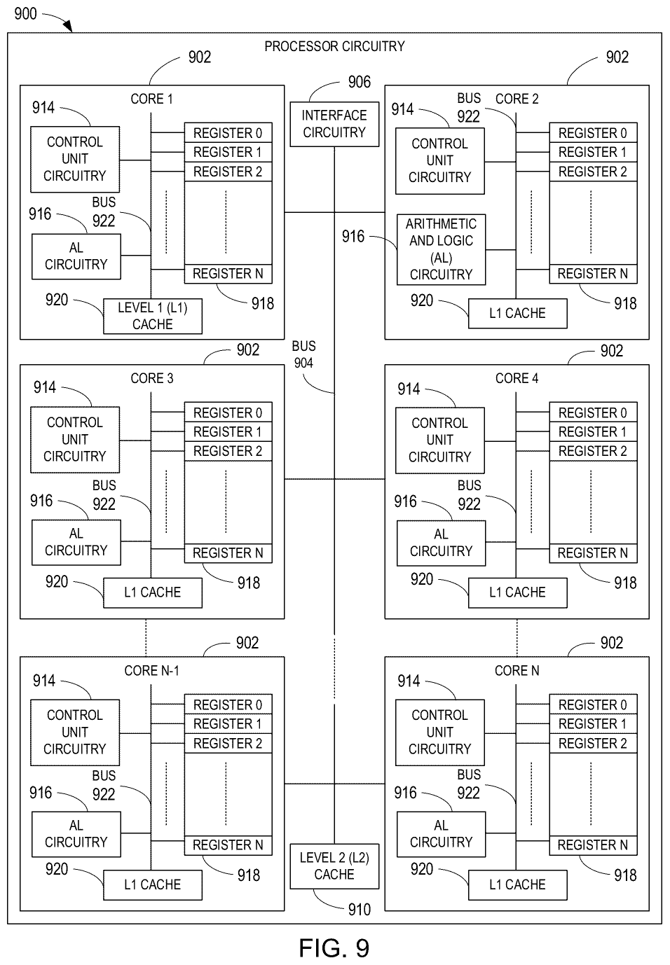

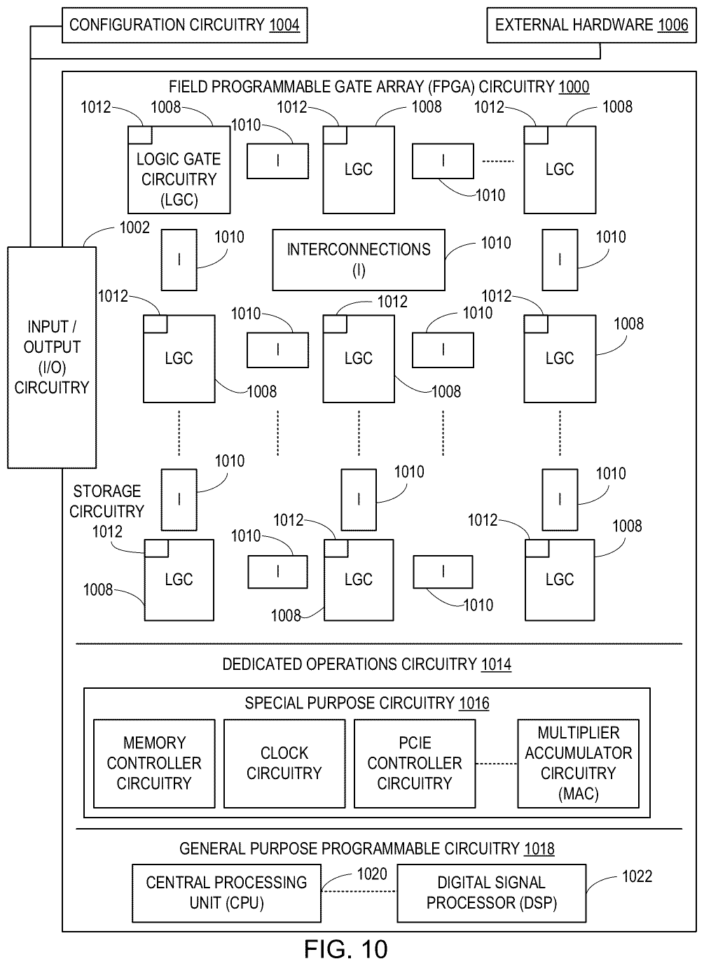

With reference to FIG. 1-3 and the associated descriptions above, in some examples, the CNN layer 100 includes means for calculating one or more scalar kernels based on an input feature map applied to the CNN layer 100. For example, the means for calculating may be implemented by the multi-scale attention kernel circuitry 110. In some examples, the multi-scale attention kernel circuitry 110 may be instantiated by processor circuitry such as the example processor circuitry 812 of FIG. 8. For instance, the multi-scale attention kernel circuitry 110 may be instantiated by the example general purpose processor circuitry 900 of FIG. 9 executing machine executable instructions such as that implemented by at least blocks of FIGS. 4, 5, 6 and/or 7. In some examples, the multi-scale attention kernel circuitry 110 may be instantiated by hardware logic circuitry, which may be implemented by an ASIC or the FPGA circuitry 1000 of FIG. 10 structured to perform operations corresponding to the machine readable instructions. Additionally or alternatively, the multi-scale attention kernel circuitry 110 may be instantiated by any other combination of hardware, software, and/or firmware. For example, the multi-scale attention kernel circuitry 110 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

With reference to FIG. 1-3 and the associated descriptions above, in some examples, the CNN layer 100 includes means for scaling elements of a static multidimensional convolutional filter associated with that CNN layer 100 by one or more scalar kernels. For example, the means for scaling may be implemented by the dimensional scaling circuitry 115. In some examples, the dimensional scaling circuitry 115 may be instantiated by processor circuitry such as the example processor circuitry 812 of FIG. 8. For instance, the dimensional scaling circuitry 115 may be instantiated by the example general purpose processor circuitry 900 of FIG. 9 executing machine executable instructions such as that implemented by at least blocks of FIGS. 4, 5, 6 and/or 7. In some examples, the dimensional scaling circuitry 115 may be instantiated by hardware logic circuitry, which may be implemented by an ASIC or the FPGA circuitry 1000 of FIG. 10 structured to perform operations corresponding to the machine readable instructions. Additionally or alternatively, the dimensional scaling circuitry 115 may be instantiated by any other combination of hardware, software, and/or firmware. For example, the dimensional scaling circuitry 115 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While example manners of implementing the CNN layer 100 is illustrated in FIGS. 1-3, one or more of the elements, processes, and/or devices illustrated in FIGS. 1-3 may be combined, divided, re-arranged, omitted, eliminated, and/or implemented in any other way. Further, the example convolutional layer circuitry 105, the example multi-scale attention kernel circuitry 110, the example dimensional scaling circuitry 115, the example static multidimensional convolutional filter 120, the example batch normalizer 125, the example activation function 130, the example input interface 138, the example output interface 142, the example spatial transformation circuitry 205, the example channel squeeze transformation circuitry 210, the example map and scale transformation circuitry 245-255, the example GAP circuitry 305, the example FC layer 310, the example batch normalizer 315, the example activation function 320, the example FC layers 345-355, the example activation functions 365-375 and/or, more generally, the CNN layer 100, may be implemented by hardware alone or by hardware in combination with software and/or firmware. Thus, for example, any of the example convolutional layer circuitry 105, the example multi-scale attention kernel circuitry 110, the example dimensional scaling circuitry 115, the example static multidimensional convolutional filter 120, the example batch normalizer 125, the example activation function 130, the example input interface 138, the example output interface 142, the example spatial transformation circuitry 205, the example channel squeeze transformation circuitry 210, the example map and scale transformation circuitry 245-255, the example GAP circuitry 305, the example FC layer 310, the example batch normalizer 315, the example activation function 320, the example FC layers 345-355, the example activation functions 365-375, and/or, more generally, the example CNN layer 100, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example CNN layer 100 may include one or more elements, processes, and/or devices in addition to, or instead of, those illustrated in FIGS. 1-3, and/or may include more than one of any or all of the illustrated elements, processes and devices.

Flowcharts representative of example hardware logic circuitry, machine readable instructions, hardware implemented state machines, and/or any combination thereof for implementing the CNN layer 100 of FIGS. 1-3 are shown in FIGS. 4-7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program(s) may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program(s) and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is(are) described with reference to the flowcharts illustrated in FIGS. 4-7, many other methods of implementing the example CNN layer 100 may alternatively be used. For example, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media. Also, as used herein, the terms “computer readable” and “machine readable” are considered equivalent unless indicated otherwise.

Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

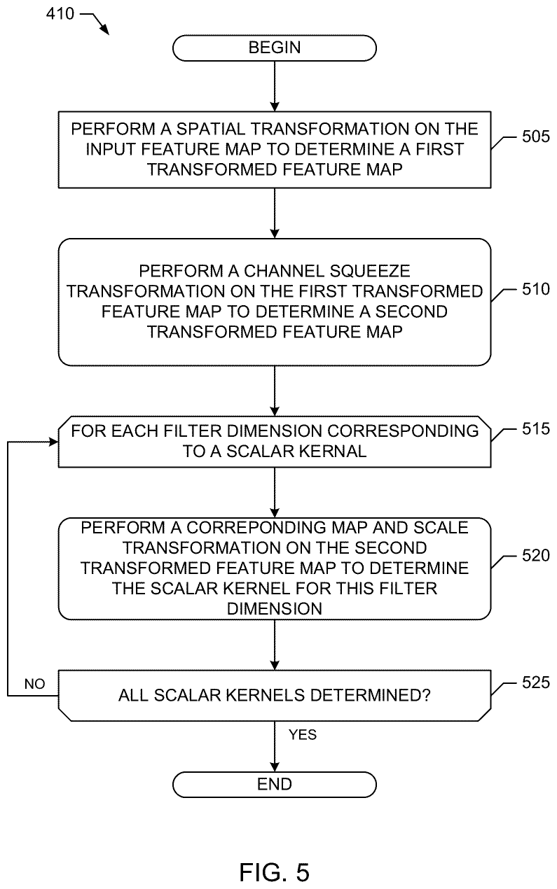

FIG. 4 is a flowchart representative of example machine readable instructions and/or example operations 400 that may be executed and/or instantiated by processor circuitry to implement the example CNN layer 100 of FIGS. 1-3. With reference to the preceding figures and associated written descriptions, the machine readable instructions and/or the operations 400 of FIG. 4 begin at block 405, at which the example input interface 138 of the CNN layer 100 accesses the example input feature map 135 applied to the CNN layer 100. At block 410, the multi-scale attention kernel circuitry 110 of the CNN layer 100 calculates, as described above, one or more of the example scalar kernels 145-155 based on the input feature map 135. As described above, the scalar kernels 145-155 correspond to respective dimensions of the static, multidimensional convolutional filter 120 associated with the CNN layer 100. An example implementation of block 410 of FIG. 4 is illustrated in FIG. 5, which is described in further detail below.

At block 415, the example dimensional scaling circuitry 115 of the CNN layer 100 scales, as described above, the elements of the static, multidimensional convolutional filter 120 based on the one or more scalar kernels calculated at block 410 to produce a dynamic, multidimensional convolutional filter associated with the CNN layer 100. At block 420, the example convolutional layer circuitry 105 of the CNN layer 100 processes, as described above, the input feature map 135 with the dynamic, multidimensional convolutional filter produced at block 415 to obtain the example output feature map 140, which is output by the example output interface 142 of the CNN layer 100 for that input feature map 135. In some examples, execution of the example machine readable instructions and/or example operations 400 returns to block 405 to process a new input feature map 135 to produce a new output feature map 140 for that new input. Otherwise, execution of the example machine readable instructions and/or example operations 400 ends.

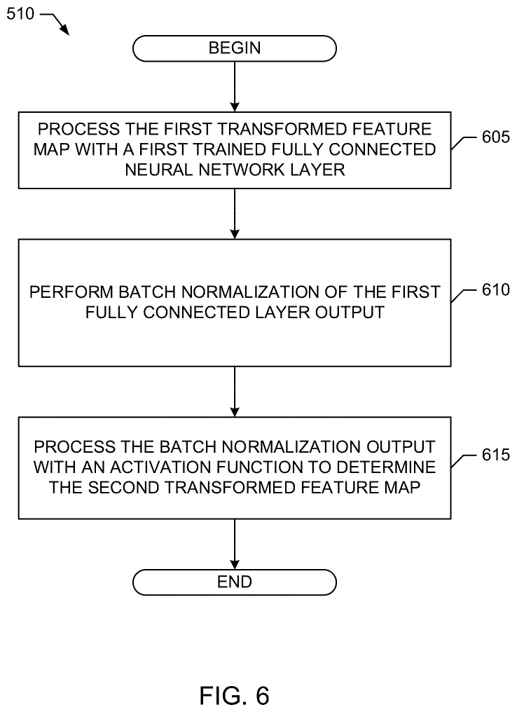

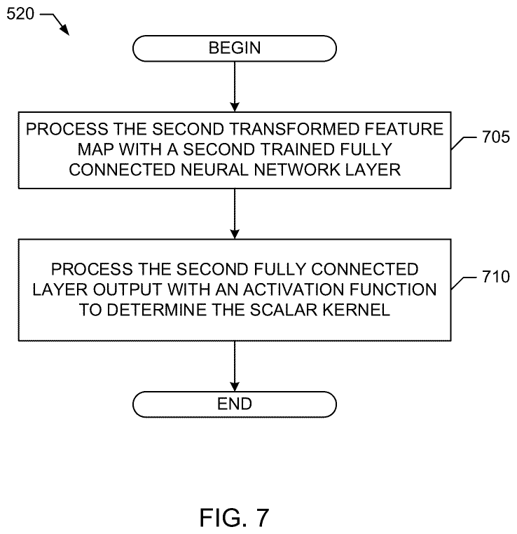

FIG. 5 is a flowchart representative of example machine readable instructions and/or example operations 410 that may be executed and/or instantiated by processor circuitry to implement the example multi-scale attention kernel circuitry 110 of FIGS. 1-3, and/or the example processing of block 410 of FIG. 4. With reference to the preceding figures and associated written descriptions, the machine readable instructions and/or the operations 410 of FIG. 5 begin at block 505, at which the example spatial transformation circuitry 205 of the multi-scale attention kernel circuitry 110 performs, as described above, an example spatial transformation on the input feature map 135 to determine a first example transformed feature map (or channel descriptor). At block 510, the example channel squeeze transformation circuitry 210 of the multi-scale attention kernel circuitry 110 performs, as described above, an example channel squeeze transformation on the first transformed feature map (or channel descriptor) obtained at block 505 to determine a second example transformed feature map (or abstraction descriptor). An example implementation of block 510 of FIG. 5 is illustrated in FIG. 6, which is described in further detail below. At block 515, 520 and 525, the respective instances of the example map and scale transformation circuitry 245-255 of the multi-scale attention kernel circuitry 110 perform, as described above, corresponding map and scale transformations on the second transformed feature map (or abstraction descriptor) obtained at block 510 to determine the respective scalar kernels 145, 150 and 155, for the different dimensions of the filter (kernel) space. An example implementation of block 520 of FIG. 5 is illustrated in FIG. 7, which is described in further detail below. Execution of the example machine readable instructions and/or example operations 500 then ends.

FIG. 6 is a flowchart representative of example machine readable instructions and/or example operations 510 that may be executed and/or instantiated by processor circuitry to implement the example channel squeeze transformation circuitry 210 of the example multi-scale attention kernel circuitry 110 of FIGS. 2-3, and/or the example processing of block 510 of FIG. 5. With reference to the preceding figures and associated written descriptions, the machine readable instructions and/or the operations 510 of FIG. 6 begin at block 605, at which the channel squeeze transformation circuitry 210 processes the first transformed feature map (or channel descriptor) with the example FC layer 310, as described above. At block 610, the channel squeeze transformation circuitry 210 uses the example batch normalizer 315 to perform batch normalization on the output of the FC layer 310 obtained at block 605, as described above. At block 615, the channel squeeze transformation circuitry 210 processes the output of the batch normalizer 315 obtained at block 610 with the example activation function 320 to determine the second transformed feature map (or abstraction descriptor), as described above. Execution of the example machine readable instructions and/or example operations 510 then ends.

FIG. 7 is a flowchart representative of example machine readable instructions and/or example operations 520 that may be executed and/or instantiated by processor circuitry to implement a given instance of the example map and scale transformation circuitry 245-255 of the example multi-scale attention kernel circuitry 110 of FIGS. 2-3, and/or the example processing of block 520 of FIG. 6. With reference to the preceding figures and associated written descriptions, the machine readable instructions and/or the operations 520 of FIG. 7 begin at block 705, at which the given instance of the example map and scale transformation circuitry 245-255 processes the second transformed feature map (or abstraction descriptor) with the respective instance of the example FC layer 345-355, as described above. At block 710, the given instance of the example map and scale transformation circuitry 245-255 processes the output of the respective instance of the example FC layer 345-355 obtained at block 705 with the respective instance of the example activation function 365-375 to determine the respective scalar kernel 145-155 corresponding to the given circuit instance, as described above. Execution of the example machine readable instructions and/or example operations 520 then ends.

FIG. 8 is a block diagram of an example processor platform 800 structured to execute and/or instantiate the machine readable instructions and/or the operations of FIGS. 4, 5, 6 and/or 7 to implement the CNN layer 100 of FIGS. 1-3. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In some examples, the processor circuitry 812 implements the example convolutional layer circuitry 105, the example multi-scale attention kernel circuitry 110, the example dimensional scaling circuitry 115, the example static multidimensional convolutional filter 120, the example batch normalizer 125, the example activation function 130, the example input interface 138, the example output interface 142, the example spatial transformation circuitry 205, the example channel squeeze transformation circuitry 210, the example map and scale transformation circuitry 245-255, the example GAP circuitry 305, the example FC layer 310, the example batch normalizer 315, the example activation function 320, the example FC layers 345-355 and/or the example activation functions 365-375 of the CNN layer 100.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 820 implements the example input interface 138 and/or the example output interface 142 of the CNN layer 100.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, a trackbar, an isopoint device, a voice recognition system and/or any other human-machine interface. In some examples, the input device(s) 822 are arranged or otherwise configured to allow the user to control the processor platform 800 and provide data to the processor platform 800 using physical gestures, such as, but not limited to, hand or body movements, facial expressions, face recognition, etc.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 832, which may be implemented by the machine readable instructions of FIGS. 4, 5, 6 and/or 7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a general purpose microprocessor 900. The general purpose microprocessor circuitry 900 executes some or all of the machine readable instructions of the flowcharts of FIGS. 4, 5, 6 and/or 7 to effectively instantiate the CNN layer 100 of FIGS. 1-3 as logic circuits to perform the operations corresponding to those machine readable instructions. In some such examples, the circuitry of FIGS. 1-3 is instantiated by the hardware circuits of the microprocessor 900 in combination with the instructions. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 4, 5, 6 and/or 7.

The cores 902 may communicate by a first example bus 904. In some examples, the first bus 904 may implement a communication bus to effectuate communication associated with one(s) of the cores 902. For example, the first bus 904 may implement at least one of an Inter-Integrated Circuit (I2C) bus, a Serial Peripheral Interface (SPI) bus, a PCI bus, or a PCIe bus. Additionally or alternatively, the first bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The ALU circuitry 916 includes semiconductor-based circuits structured to perform one or more mathematic and/or logic operations on the data within the corresponding core 902. The ALU circuitry 916 of some examples performs integer based operations. In other examples, the ALU circuitry 916 also performs floating point operations. In yet other examples, the ALU circuitry 916 may include first AL circuitry that performs integer based operations and second ALU circuitry that performs floating point operations. In some examples, the ALU circuitry 916 may be referred to as an Arithmetic Logic Unit (ALU). The registers 918 are semiconductor-based structures to store data and/or instructions such as results of one or more of the operations performed by the ALU circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may implement at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 4, 5, 6 and/or 7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowchart of FIGS. 4, 5, 6 and/or 7. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry s00 is reprogrammed). The configured logic circuits enable the logic gates to cooperate in different ways to perform different operations on data received by input circuitry. Those operations may correspond to some or all of the software represented by the flowchart of FIGS. 4, 5, 6 and/or 7. As such, the FPGA circuitry 1000 may be structured to effectively instantiate some or all of the machine readable instructions of the flowchart of FIGS. 4, 5, 6 and/or 7 as dedicated logic circuits to perform the operations corresponding to those software instructions in a dedicated manner analogous to an ASIC. Therefore, the FPGA circuitry s00 may perform the operations corresponding to the some or all of the machine readable instructions of FIGS. 4, 5, 6 and/or 7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware (e.g., external hardware circuitry) 1006. For example, the configuration circuitry 1004 may implement interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may implement the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions of FIGS. 4, 5, 6 and/or 7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowcharts of FIGS. 4, 5, 6 and/or 7 may be executed by one or more of the cores 902 of FIG. 9, a second portion of the machine readable instructions represented by the flowcharts of FIGS. 4, 5, 6 and/or 7 may be executed by the FPGA circuitry 1000 of FIG. 10, and/or a third portion of the machine readable instructions represented by the flowcharts of FIGS. 4, 5, 6 and/or 7 may be executed by an ASIC. It should be understood that some or all of the circuitry of FIGS. 1-3 may, thus, be instantiated at the same or different times. Some or all of the circuitry may be instantiated, for example, in one or more threads executing concurrently and/or in series. Moreover, in some examples, some or all of the circuitry of FIGS. 1-3 may be implemented within one or more virtual machines and/or containers executing on the microprocessor.

In some examples, the processor circuitry 812 of FIG. 8 may be in one or more packages. For example, the processor circuitry 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

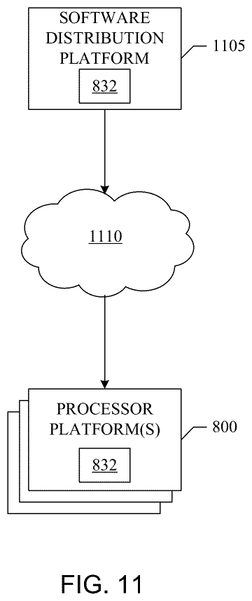

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 4, 5, 6 and/or 7, as described above. The one or more servers of the example software distribution platform 1105 are in communication with a network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 4, 5, 6 and/or 7, may be downloaded to the example processor platform 400, which is to execute the machine readable instructions 832 to implement the 10. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed that implement dynamic triplet convolution for convolutional neural networks. Disclosed systems, methods, apparatus, and articles of manufacture improve the efficiency of using a computing device by learning attentive scalar kernels along three dimensions of the filter (kernel) space at a given CNN layer through a multi-scale attention mechanism. After being scaled (e.g., element-wise multiplied) by the three attentive scalar kernels, the static multidimensional convolutional filter in that given CNN layer becomes dynamically conditioned on the input feature map and specialized for each of the dimensions of filer (kernel) space. Replacing conventional convolution with dynamic triplet convolution, as disclosed herein, can improve inference accuracy of the layer(s) of a CNN, while maintaining a memory efficient implementation. Also, being a drop-in design, dynamic triplet convolution techniques, as disclosed herein, can be readily plugged into any CNN architecture and boost the performance for tasks such as high-performance image analysis, classification, etc. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to implement dynamic triplet convolution for convolutional neural networks are disclosed herein. Further examples and combinations thereof include the following.

Example 1 includes an apparatus for a convolutional neural network, the apparatus comprising at least one memory, computer readable instructions, and processor circuitry to execute the computer readable instructions to at least calculate one or more scalar kernels based on an input feature map applied to a layer of the convolutional neural network, ones of the one or more scalar kernels corresponding to respective dimensions of a static multidimensional convolutional filter associated with the layer of the convolutional neural network, and scale elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

Example 2 includes the apparatus of example 1, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

Example 3 includes the apparatus of example 2, wherein the first scalar kernel includes a first number of elements corresponding respectively to positions of the static multidimensional convolutional filter along the spatial dimension, the second scalar kernel includes a second number of elements corresponding respectively to positions of the static multidimensional convolutional filter along the input channel dimension, and the third scalar kernel includes a third number of elements corresponding respectively to positions of the static multidimensional convolutional filter along the output filter dimension.

Example 4 includes the apparatus of example 2, wherein to determine the dynamic multidimensional convolutional filter, the processor circuitry is to at least one of multiply respective ones of the elements of the static multidimensional filter along the spatial dimension by corresponding ones of the first number of elements of the first scalar kernel, multiply respective ones of the elements of the static multidimensional filter along the input channel dimension by corresponding ones of the second number of elements of the second scalar kernel, or multiply respective ones of the elements of the static multidimensional filter along the output channel dimension by corresponding ones of the third number of elements of the third scalar kernel.

Example 5 includes the apparatus of example 1, wherein the input feature map has a spatial dimension and an input channel dimension, and to calculate the first one of the one or more scalar kernels corresponding to the first one of the dimensions, the processor circuitry is to perform a spatial transformation on the input feature map to determine a first transformed feature map, perform a channel squeeze transformation on the first transformed feature map to determine a second transformed feature map, and perform a map and scale transformation on the second transformed feature map to determine the first one of the one or more scalar kernels.

Example 6 includes the apparatus of example 5, wherein to perform the spatial transformation, the processor circuitry is to perform global average pooling across the spatial dimension of the input feature map to determine the first transformed feature map.

Example 7 includes the apparatus of example 5, wherein to perform the channel squeeze transformation, the processor circuitry is to process the first transformed feature map with a trained fully connected neural network layer to determine a fully connected layer output, perform batch normalization of the fully connected layer output to determine a batch normalization output, and process the batch normalization output with an activation function to determine the second transformed feature map.

Example 8 includes the apparatus of example 5, wherein to perform the map and scale transformation, the processor circuitry is to process the second transformed feature map with a trained fully connected neural network layer to determine a fully connected layer output, and process the fully connected layer output with an activation function to determine the first one of the one or more scalar kernels.

Example 9 includes the apparatus of example 5, wherein the channel squeeze transformation is based on a first trained fully connected neural network layer, and the map and scale transformation is based on a different, second trained fully connected neural network layer.

Example 10 includes the apparatus of any one of examples 1 to 9, wherein the processor circuitry is to process the input feature map with the dynamic multidimensional convolutional filter to determine an output feature map of the layer of the convolutional neural network.

Example 11 includes the apparatus of example 10, wherein the input feature map is a first input feature map, the one or more scalar kernels are a first one or more scalar kernels, the dynamic multidimensional convolutional filter is a first dynamic multidimensional convolutional filter, the output feature map is a first output feature map, and the processor circuitry is to calculate a second one or more scalar kernels based on a second input feature map applied to the layer of the convolutional neural network, and scale elements of the static multidimensional convolutional filter along a first one of the dimensions based on a first one of the second one or more scalar kernels corresponding to the first one of the dimensions to determine a second dynamic multidimensional convolutional filter associated with the layer of the convolutional neural network, and process the second input feature map with the second dynamic multidimensional convolutional filter to determine a second output feature map of the layer of the convolutional neural network.

Example 12 includes the apparatus of any one of examples 1 to 11, wherein the processor circuitry is to train the static multidimensional convolutional filter based on training data during a training mode of the convolutional neural network, and calculate the one or more scalar kernels during an inference mode of the convolutional neural network.

Example 13 includes at least one non-transitory computer readable medium comprising computer readable instructions that, when executed, cause at least one processor to at least calculate one or more scalar kernels based on an input feature map applied to a layer of a convolutional neural network, ones of the one or more scalar kernels corresponding to respective dimensions of a static multidimensional convolutional filter associated with the layer of the convolutional neural network, and scale elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

Example 14 includes the at least one non-transitory computer readable medium of example 13, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

Example 15 includes the at least one non-transitory computer readable medium of example 14, wherein the first scalar kernel includes a first number of elements corresponding respectively to positions of the static multidimensional convolutional filter along the spatial dimension, the second scalar kernel includes a second number of elements corresponding respectively to positions of the static multidimensional convolutional filter along the input channel dimension, and the third scalar kernel includes a third number of elements corresponding respectively to positions of the static multidimensional convolutional filter along the output filter dimension.

Example 16 includes the at least one non-transitory computer readable medium of example 14, wherein to determine the dynamic multidimensional convolutional filter, the instructions are to cause the at least one processor to at least one of multiply respective ones of the elements of the static multidimensional filter along the spatial dimension by corresponding ones of the first number of elements of the first scalar kernel, multiply respective ones of the elements of the static multidimensional filter along the input channel dimension by corresponding ones of the second number of elements of the second scalar kernel, or multiply respective ones of the elements of the static multidimensional filter along the output channel dimension by corresponding ones of the third number of elements of the third scalar kernel.

Example 17 includes the at least one non-transitory computer readable medium of example 13, wherein the input feature map has a spatial dimension and an input channel dimension, and to calculate the first one of the one or more scalar kernels corresponding to the first one of the dimensions, the instructions are to cause the at least one processor to perform a spatial transformation on the input feature map to determine a first transformed feature map, perform a channel squeeze transformation on the first transformed feature map to determine a second transformed feature map, and perform a map and scale transformation on the second transformed feature map to determine the first one of the one or more scalar kernels.

Example 18 includes the at least one non-transitory computer readable medium of example 17, wherein to perform the spatial transformation, the instructions are to cause the at least one processor to perform global average pooling across the spatial dimension of the input feature map to determine the first transformed feature map.

Example 19 includes the at least one non-transitory computer readable medium of example 17, wherein to perform the channel squeeze transformation, the instructions are to cause the at least one processor to process the first transformed feature map with a trained fully connected neural network layer to determine a fully connected layer output, perform batch normalization of the fully connected layer output to determine a batch normalization output, and process the batch normalization output with an activation function to determine the second transformed feature map.

Example 20 includes the at least one non-transitory computer readable medium of example 17, wherein to perform the map and scale transformation, the instructions are to cause the at least one processor to process the second transformed feature map with a trained fully connected neural network layer to determine a fully connected layer output, and process the fully connected layer output with an activation function to determine the first one of the one or more scalar kernels.

Example 21 includes the at least one non-transitory computer readable medium of example 17, wherein the channel squeeze transformation is based on a first trained fully connected neural network layer, and the map and scale transformation is based on a different, second trained fully connected neural network layer.

Example 22 includes the at least one non-transitory computer readable medium of any one of examples 13 to 21, wherein the instructions are to cause the at least one processor to process the input feature map with the dynamic multidimensional convolutional filter to determine an output feature map of the layer of the convolutional neural network.

Example 23 includes the at least one non-transitory computer readable medium of example 22, wherein the input feature map is a first input feature map, the one or more scalar kernels are a first one or more scalar kernels, the dynamic multidimensional convolutional filter is a first dynamic multidimensional convolutional filter, the output feature map is a first output feature map, and the instructions are to cause the at least one processor to calculate a second one or more scalar kernels based on a second input feature map applied to the layer of the convolutional neural network, and scale elements of the static multidimensional convolutional filter along a first one of the dimensions based on a first one of the second one or more scalar kernels corresponding to the first one of the dimensions to determine a second dynamic multidimensional convolutional filter associated with the layer of the convolutional neural network, and process the second input feature map with the second dynamic multidimensional convolutional filter to determine a second output feature map of the layer of the convolutional neural network.

Example 24 includes the at least one non-transitory computer readable medium of any one of examples 13 to 23, wherein the instructions are to cause the at least one processor to train the static multidimensional convolutional filter based on training data during a training mode of the convolutional neural network, and calculate the one or more scalar kernels during an inference mode of the convolutional neural network.

Example 25 includes a method for a convolutional neural network, the method comprising calculating, by executing an instruction with at least one processor, one or more scalar kernels based on an input feature map applied to a layer of a convolutional neural network, ones of the one or more scalar kernels corresponding to respective dimensions of a static multidimensional convolutional filter associated with the layer of the convolutional neural network, and scaling, by executing an instruction with the at least one processor, elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

Example 26 includes the method of example 25, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

Example 27 includes the method of example 26, wherein the first scalar kernel includes a first number of elements corresponding respectively to positions of the static multidimensional convolutional filter along the spatial dimension, the second scalar kernel includes a second number of elements corresponding respectively to positions of the static multidimensional convolutional filter along the input channel dimension, and the third scalar kernel includes a third number of elements corresponding respectively to positions of the static multidimensional convolutional filter along the output filter dimension.

Example 28 includes the method of example 26, wherein the scaling includes at least one of multiplying respective ones of the elements of the static multidimensional filter along the spatial dimension by corresponding ones of the first number of elements of the first scalar kernel, multiplying respective ones of the elements of the static multidimensional filter along the input channel dimension by corresponding ones of the second number of elements of the second scalar kernel, or multiplying respective ones of the elements of the static multidimensional filter along the output channel dimension by corresponding ones of the third number of elements of the third scalar kernel.

Example 29 includes the method of example 25, wherein the input feature map has a spatial dimension and an input channel dimension, and the calculating of the first one of the one or more scalar kernels corresponding to the first one of the dimensions includes performing a spatial transformation on the input feature map to determine a first transformed feature map, performing a channel squeeze transformation on the first transformed feature map to determine a second transformed feature map, and performing a map and scale transformation on the second transformed feature map to determine the first one of the one or more scalar kernels.

Example 30 includes the method of example 29, wherein performing the spatial transformation includes performing global average pooling across the spatial dimension of the input feature map to determine the first transformed feature map.

Example 31 includes the method of example 29, wherein performing the channel squeeze transformation includes processing the first transformed feature map with a trained fully connected neural network layer to determine a fully connected layer output, performing batch normalization of the fully connected layer output to determine a batch normalization output, and processing the batch normalization output with an activation function to determine the second transformed feature map.

Example 32 includes the method of example 29, wherein performing the map and scale transformation includes processing the second transformed feature map with a trained fully connected neural network layer to determine a fully connected layer output, and processing the fully connected layer output with an activation function to determine the first one of the one or more scalar kernels.

Example 33 includes the method of example 29, wherein the channel squeeze transformation is based on a first trained fully connected neural network layer, and the map and scale transformation is based on a different, second trained fully connected neural network layer.

Example 34 includes the method of any one of examples 25 to 33, further including processing the input feature map with the dynamic multidimensional convolutional filter to determine an output feature map of the layer of the convolutional neural network.

Example 35 includes the method of example 34, wherein the input feature map is a first input feature map, the one or more scalar kernels are a first one or more scalar kernels, the dynamic multidimensional convolutional filter is a first dynamic multidimensional convolutional filter, the output feature map is a first output feature map, and further including calculating a second one or more scalar kernels based on a second input feature map applied to the layer of the convolutional neural network, and scaling elements of the static multidimensional convolutional filter along a first one of the dimensions based on a first one of the second one or more scalar kernels corresponding to the first one of the dimensions to determine a second dynamic multidimensional convolutional filter associated with the layer of the convolutional neural network, and processing the second input feature map with the second dynamic multidimensional convolutional filter to determine a second output feature map of the layer of the convolutional neural network.

Example 36 includes the method of any one of examples 25 to 35, further including training the static multidimensional convolutional filter based on training data during a training mode of the convolutional neural network, and calculating the one or more scalar kernels during an inference mode of the convolutional neural network.

Example 37 includes an apparatus to a convolutional neural network, the apparatus comprising interface circuitry to access an input feature map applied to a layer of the convolutional neural network, and processor circuitry including one or more of at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrate Circuitry (ASIC) including logic gate circuitry to perform one or more third operations, the processor circuitry to perform at least one of the first operations, the second operations, or the third operations to instantiate multi-scale attention kernel circuitry to calculate one or more scalar kernels based on an input feature map applied to a layer of the convolutional neural network, ones of the one or more scalar kernels corresponding to respective dimensions of a static multidimensional convolutional filter associated with the layer of the convolutional neural network, and dimensional scaling circuitry to scale elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

Example 38 includes the apparatus of example 37, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

Example 39 includes the apparatus of example 38, wherein the first scalar kernel includes a first number of elements corresponding respectively to positions of the static multidimensional convolutional filter along the spatial dimension, the second scalar kernel includes a second number of elements corresponding respectively to positions of the static multidimensional convolutional filter along the input channel dimension, and the third scalar kernel includes a third number of elements corresponding respectively to positions of the static multidimensional convolutional filter along the output filter dimension.

Example 40 includes the apparatus of example 38, wherein the dimensional scaling circuitry is to at least one of multiply respective ones of the elements of the static multidimensional filter along the spatial dimension by corresponding ones of the first number of elements of the first scalar kernel, multiply respective ones of the elements of the static multidimensional filter along the input channel dimension by corresponding ones of the second number of elements of the second scalar kernel, or multiply respective ones of the elements of the static multidimensional filter along the output channel dimension by corresponding ones of the third number of elements of the third scalar kernel.

Example 41 includes the apparatus of example 37, wherein the input feature map has a spatial dimension and an input channel dimension, and to calculate the first one of the one or more scalar kernels corresponding to the first one of the dimensions, the multi-scale attention kernel circuitry is to perform a spatial transformation on the input feature map to determine a first transformed feature map, perform a channel squeeze transformation on the first transformed feature map to determine a second transformed feature map, and perform a map and scale transformation on the second transformed feature map to determine the first one of the one or more scalar kernels.

Example 42 includes the apparatus of example 41, wherein to perform the spatial transformation, the multi-scale attention kernel circuitry is to perform global average pooling across the spatial dimension of the input feature map to determine the first transformed feature map.

Example 43 includes the apparatus of example 41, wherein to perform the channel squeeze transformation, the multi-scale attention kernel circuitry is to process the first transformed feature map with a trained fully connected neural network layer to determine a fully connected layer output, perform batch normalization of the fully connected layer output to determine a batch normalization output, and process the batch normalization output with an activation function to determine the second transformed feature map.

Example 44 includes the apparatus of example 41, wherein to perform the map and scale transformation, the multi-scale attention kernel circuitry is to process the second transformed feature map with a trained fully connected neural network layer to determine a fully connected layer output, and process the fully connected layer output with an activation function to determine the first one of the one or more scalar kernels.

Example 45 includes the apparatus of example 41, wherein the channel squeeze transformation is based on a first trained fully connected neural network layer, and the map and scale transformation is based on a different, second trained fully connected neural network layer.

Example 46 includes the apparatus of any one of examples 37 to 45, wherein the processor circuitry to perform at least one of the first operations, the second operations, or the third operations to instantiate convolutional layer circuitry to process the input feature map with the dynamic multidimensional convolutional filter to determine an output feature map of the layer of the convolutional neural network.

Example 47 includes the apparatus of example 46, wherein the input feature map is a first input feature map, the one or more scalar kernels are a first one or more scalar kernels, the dynamic multidimensional convolutional filter is a first dynamic multidimensional convolutional filter, the output feature map is a first output feature map, and the multi-scale attention kernel circuitry is to calculate a second one or more scalar kernels based on a second input feature map applied to the layer of the convolutional neural network, and the dimensional scaling circuitry is to scale elements of the static multidimensional convolutional filter along a first one of the dimensions based on a first one of the second one or more scalar kernels corresponding to the first one of the dimensions to determine a second dynamic multidimensional convolutional filter associated with the layer of the convolutional neural network, and the convolutional layer circuitry is to process the second input feature map with the second dynamic multidimensional convolutional filter to determine a second output feature map of the layer of the convolutional neural network.

Example 48 includes the apparatus of any one of examples 37 to 48, wherein the processor circuitry is to train the static multidimensional convolutional filter based on training data during a training mode of the convolutional neural network, and calculate the one or more scalar kernels during an inference mode of the convolutional neural network.

Example 49 includes at least one computer readable medium comprising computer readable instructions that, when executed, cause at least one processor to perform the method of any one of examples 25 to 36.

Example 50 includes an apparatus comprising at least one processor to perform the method of any one of examples 25 to 36.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1-48. (canceled)

49. An apparatus for a convolutional neural network, the apparatus comprising:
at least one memory;
computer readable instructions; and
processor circuitry to execute the computer readable instructions to at least:
calculate one or more scalar kernels based on an input feature map applied to a layer of the convolutional neural network, ones of the one or more scalar kernels corresponding to respective dimensions of a static multidimensional convolutional filter associated with the layer of the convolutional neural network; and
scale elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

50. The apparatus of claim 49, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

51. The apparatus of claim 50, wherein the first scalar kernel includes a first number of elements corresponding respectively to positions of the static multidimensional convolutional filter along the spatial dimension, the second scalar kernel includes a second number of elements corresponding respectively to positions of the static multidimensional convolutional filter along the input channel dimension, and the third scalar kernel includes a third number of elements corresponding respectively to positions of the static multidimensional convolutional filter along the output filter dimension.

52. The apparatus of claim 51, wherein to determine the dynamic multidimensional convolutional filter, the processor circuitry is to at least one of:
multiply respective ones of the elements of the static multidimensional filter along the spatial dimension by corresponding ones of the first number of elements of the first scalar kernel;
multiply respective ones of the elements of the static multidimensional filter along the input channel dimension by corresponding ones of the second number of elements of the second scalar kernel; or
multiply respective ones of the elements of the static multidimensional filter along the output channel dimension by corresponding ones of the third number of elements of the third scalar kernel.

53. The apparatus of claim 49, wherein the input feature map has a spatial dimension and an input channel dimension, and to calculate the first one of the one or more scalar kernels corresponding to the first one of the dimensions, the processor circuitry is to:
perform a spatial transformation on the input feature map to determine a first transformed feature map;
perform a channel squeeze transformation on the first transformed feature map to determine a second transformed feature map; and
perform a map and scale transformation on the second transformed feature map to determine the first one of the one or more scalar kernels.

54. The apparatus of claim 53, wherein to perform the spatial transformation, the processor circuitry is to perform global average pooling across the spatial dimension of the input feature map to determine the first transformed feature map.

55. The apparatus of claim 53, wherein to perform the channel squeeze transformation, the processor circuitry is to:
process the first transformed feature map with a trained fully connected neural network layer to determine a fully connected layer output;
perform batch normalization of the fully connected layer output to determine a batch normalization output; and
process the batch normalization output with an activation function to determine the second transformed feature map.

56. The apparatus of claim 53, wherein to perform the map and scale transformation, the processor circuitry is to:
process the second transformed feature map with a trained fully connected neural network layer to determine a fully connected layer output; and
process the fully connected layer output with an activation function to determine the first one of the one or more scalar kernels.

57. The apparatus of claim 53, wherein the channel squeeze transformation is based on a first trained fully connected neural network layer, and the map and scale transformation is based on a different, second trained fully connected neural network layer.

58. The apparatus of claim 49, wherein the processor circuitry is to process the input feature map with the dynamic multidimensional convolutional filter to determine an output feature map of the layer of the convolutional neural network.

59. The apparatus of claim 58, wherein the input feature map is a first input feature map, the one or more scalar kernels are a first one or more scalar kernels, the dynamic multidimensional convolutional filter is a first dynamic multidimensional convolutional filter, the output feature map is a first output feature map, and the processor circuitry is to:
calculate a second one or more scalar kernels based on a second input feature map applied to the layer of the convolutional neural network; and
scale elements of the static multidimensional convolutional filter along a first one of the dimensions based on a first one of the second one or more scalar kernels corresponding to the first one of the dimensions to determine a second dynamic multidimensional convolutional filter associated with the layer of the convolutional neural network; and
process the second input feature map with the second dynamic multidimensional convolutional filter to determine a second output feature map of the layer of the convolutional neural network.

60. The apparatus of claim 49, wherein the processor circuitry is to:
train the static multidimensional convolutional filter based on training data during a training mode of the convolutional neural network; and
calculate the one or more scalar kernels during an inference mode of the convolutional neural network.

61. At least one non-transitory computer readable medium comprising computer readable instructions that, when executed, cause at least one processor to at least:
calculate one or more scalar kernels based on an input feature map applied to a layer of a convolutional neural network, ones of the one or more scalar kernels corresponding to respective dimensions of a static multidimensional convolutional filter associated with the layer of the convolutional neural network; and
scale elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

62. The at least one non-transitory computer readable medium of claim 61, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

63. The at least one non-transitory computer readable medium of claim 62, wherein to determine the dynamic multidimensional convolutional filter, the instructions are to cause the at least one processor to at least one of:
multiply respective elements of the static multidimensional filter along the spatial dimension by corresponding ones of a first number of elements of the first scalar kernel;
multiply respective elements of the static multidimensional filter along the input channel dimension by corresponding ones of a second number of elements of the second scalar kernel; or
multiply respective elements of the static multidimensional filter along the output channel dimension by corresponding ones of a third number of elements of the third scalar kernel.

64. The at least one non-transitory computer readable medium of claim 61, wherein the input feature map has a spatial dimension and an input channel dimension, and to calculate the first one of the one or more scalar kernels corresponding to the first one of the dimensions, the instructions are to cause the at least one processor to:
perform a spatial transformation on the input feature map to determine a first transformed feature map;
perform a channel squeeze transformation on the first transformed feature map to determine a second transformed feature map; and
perform a map and scale transformation on the second transformed feature map to determine the first one of the one or more scalar kernels.

65. A method for a convolutional neural network, the method comprising:
calculating, by executing an instruction with at least one processor, one or more scalar kernels based on an input feature map applied to a layer of A convolutional neural network, ones of the one or more scalar kernels corresponding to respective dimensions of a static multidimensional convolutional filter associated with the layer of the convolutional neural network; and
scaling, by executing an instruction with the at least one processor, elements of the static multidimensional convolutional filter along a first one of the dimensions based on a first one of the one or more scalar kernels corresponding to the first one of the dimensions to determine a dynamic multidimensional convolutional filter associated with the layer of the convolutional neural network.

66. The method of claim 65, wherein the one or more scalar kernels include a first scalar kernel corresponding to a spatial dimension of the static multidimensional convolutional filter, a second scalar kernel corresponding to an input channel dimension of the static multidimensional convolutional filter, and a third scalar kernel corresponding to an output channel dimension of the static multidimensional convolutional filter.

67. The method of claim 65, further including processing the input feature map with the dynamic multidimensional convolutional filter to determine an output feature map of the layer of the convolutional neural network.

68. The method of claim 67, wherein the input feature map is a first input feature map, the one or more scalar kernels are a first one or more scalar kernels, the dynamic multidimensional convolutional filter is a first dynamic multidimensional convolutional filter, the output feature map is a first output feature map, and further including:
calculating a second one or more scalar kernels based on a second input feature map applied to the layer of the convolutional neural network; and
scaling elements of the static multidimensional convolutional filter along a first one of the dimensions based on a first one of the second one or more scalar kernels corresponding to the first one of the dimensions to determine a second dynamic multidimensional convolutional filter associated with the layer of the convolutional neural network; and
processing the second input feature map with the second dynamic multidimensional convolutional filter to determine a second output feature map of the layer of the convolutional neural network.
